(19) United States
(12) Patent Application Publication
(10) Pub. No.: US 2011/0248706 A1
(43) Pub. Date: Oct. 13, 2011

(54) METHOD AND SYSTEM FOR NAVIGATION USING MAGNETIC DIPOLES

(75) Inventors: Clayton P. Davis, Springfield, VA (US); Mitchell R. Belzer, Baltimore, MD (US); Benjamin P. Dolgin, Alexandria, VA (US); James C. Zellner, Centreville, VA (US); John T. Ishibashi, Burke, VA (US); Joseph C. Landry, Dallas, TX (US)

(73) Assignee: Raytheon UTD, Inc., Springfield, VA (US)

(21) Appl. No.: 12/757,251

(22) Filed: Apr. 9, 2010

(51) Int. Cl. G01B 7/14

(52) U.S. Cl. 324/207.11

(57) ABSTRACT

A method of navigation includes receiving a magnetic field signal from a magnetic field transducer, the magnetic field signal proportional to sensed magnetic fields associated with magnetic field sources, in a processor, processing the magnetic field signal to determine magnetic field axes of rotation corresponding to rotations of the sensed magnetic fields, and using the magnetic field axes of rotation to render a position of the magnetic field transducer.

This invention was made with Government support under Defense Advanced Research Projects Agency (DARPA) contract number FA8650-06-C-7601 and title “Sub-Surface Navigation.”

### FIELD OF THE INVENTION

The inventive techniques and systems generally relate to navigation and, in particular, to navigation using magnetic dipoles.

### BACKGROUND

As is known in the art, the Global Positioning System (GPS) provides the public and private sectors with unprecedented navigational capabilities. However, because GPS is a so called “time-of-flight” system of tracking, it performs poorly and is unreliable when used in environments with substantial multipath signal scattering (e.g., in mountainous terrain, dense vegetation) or signal loss (e.g., in caverns, mines, and buildings). Low-frequency magnetic dipoles generate magnetic fields that are relatively insensitive to these environmental perturbations (i.e., multi-path field scattering from environmental reflections and/or signal absorption). For this reason, low-frequency magnetic dipoles have formed the basis of nearly all non-inertial positioning techniques in GPS-denied environments.

As is also known in the art, conventional dipole-based positioning techniques in GPS-denied environments are similar to so called rope-and-compass exercises, where the system equipment must be physically moved to several locations before a position can be determined and hardware orientation must always be known. Such procedures place significant constraints on an object of interest whose position is to be determined. Furthermore, these procedures are impractical for real-time or near real-time systems.

### SUMMARY

In general overview, the systems and techniques described herein enable navigation in environments where GPS is unable to operate (e.g., underground in mines, inside a basement of a building, in tunnels, underwater, etc.). More particularly, the systems and techniques enable an approach to navigation that is invariant of an orientation of an object whose position is to be determined. The position can be estimated with data collected only at that position. These features are advantageous when the object (e.g., a magnetometer receiver) is coupled to a freely moving object of interest which may include, but is not limited to, an automobile or a helmet worn by a person. Other advantages of the systems and techniques described herein include an ability to render real-time or near real-time position information, although the systems and techniques should not be construed as limited to real-time applications.

In one aspect, systems and techniques described herein are directed toward a differential geometric technique used for navigation. The differential geometric technique uses relative bearings of transmitters with respect to a receiver including, but not limited to, a three-axis magnetometer receiver. Advantageously, the process for measuring the relative bearings is invariant with respect to the receiver's orientation and, therefore, the receiver is free to rotate about a position during measurement procedures. The differential geometric technique uses magnetic field data associated with magnetic field sources and measured by the receiver to determine relative bearings of the magnetic field sources. More particularly, in some embodiments, the differential geometric technique uses magnetic field axes of rotation of the measured magnetic fields to determine the relative bearings of the magnetic field sources and to obtain a position estimate of the receiver.

Other advantages of the systems and techniques described herein include insensitivity to transmitter imbalance, orthogonality, and drift. When used with moderately stable (second-level) transmitters, the differential geometric technique is suitable for low-frequency navigation without gyroscopic compensation, although gyroscopic compensation (as well as other types of compensation) may be used to improve accuracy.

In some embodiments, a “reverse” application of the above-described differential geometric technique is used to obtain transmitter position and/or orientation defined in a predetermined coordinate system. Advantageously, the reverse differential geometric technique can obtain transmitter position/orientation with knowledge of the receiver's location, orientation, or with incomplete knowledge of location and orientation. This can save time and effort during calibration, testing, and/or maintenance in some navigation environments that may incorporate the systems and methods described herein.

In one aspect, a method of navigation includes receiving a magnetic field signal from a magnetic field transducer, the magnetic field signal proportional to sensed magnetic fields associated with magnetic field sources, in a processor, processing the magnetic field signal to determine magnetic field axes of rotation corresponding to rotations of the sensed magnetic fields, and using the magnetic field axes of rotation to render a position of the magnetic field transducer.

In further embodiments, the method includes one or more of the following features: using the magnetic field axes of rotation to render the position of the magnetic field transducer including determining orientations of the magnetic field axes of rotation relative to a predetermined coordinate system, and using the orientations of the magnetic field axes of rotation to render the position of the magnetic field transducer; the position of the magnetic field transducer is a fixed position; using the magnetic field axes of rotation to render the position of the magnetic field transducer including determining a predetermined number of angles between the magnetic field axes of rotation and rendering the position of the magnetic field transducer using the predetermined number of angles; the predetermined number of angles is at least three angles and the rendered position includes at least one of position information or orientation information; the predetermined number of angles is six angles and the rendered position includes a three-dimensional position and a three-dimensional orientation; the magnetic field transducer is a rotating magnetic field transducer; further including rendering a position of at least one of the magnetic field sources using the predetermined number of angles; the position of the magnetic field transducer corresponds to a position of an object of interest coupled to the magnetic field transducer; the magnetic field transducer includes a magnetometer; the magnetic field sources include a first spinning dipole generated at a first transmitter having a first predetermined position, a second spinning dipole generated at a second transmitter having a second predetermined position, and a third spinning dipole generated at a third transmitter having a third predetermined position, the first, second, and third predetermined positions form a triangle; the triangle is formed about a navigation area of interest including the magnetic field transducer; the magnetic field sources rotate about magnetic field source axes of rotation and are positioned to form a navigation area of interest, further including rotating each magnetic field source axis of rotation about a respective axis perpendicular to a plane formed by the magnetic field sources to align each magnetic field source axis of rotation with a successive one of the magnetic field sources, and; further including rotating at least one of the magnetic field source axes of rotation about a respective axis coincident with the plane formed by the magnetic field sources to avoid a condition in which the magnetic field transducer is coincident with a plane formed by the magnetic field associated with the at least one magnetic field axis of rotation.

In another aspect, a navigation system includes a processor to receive a magnetic field signal from a magnetic field transducer, the magnetic field signal proportional to sensed magnetic fields associated with magnetic field sources, a memory coupled to the processor, the memory including program instructions for providing navigation information by processing the magnetic field signal to determine magnetic field axes of rotation corresponding to rotations of the sensed magnetic fields, and using the magnetic field axes of rotation to render a position of the magnetic field transducer.

In further embodiments, the navigation system includes one or more of the following features: using the magnetic field axes of rotation to render a position of the magnetic field transducer includes determining orientations of the magnetic field axes of rotation relative to a predetermined coordinate system, and using the orientations of the magnetic field axes of rotation to render the position of the magnetic field transducer; the position of the magnetic field transducer is a fixed position; using the magnetic field axes of rotation to render a position of the magnetic field transducer includes determining a predetermined number of angles between the magnetic field axes of rotation, and rendering a position of the magnetic field transducer using the predetermined number of angles; the predetermined number of angles is at least three angles and the rendered position includes at least one of position information or orientation information; the predetermined number of angles is six angles and the rendered position includes a three-dimensional position and a three-dimensional orientation; the magnetic field transducer is a rotating magnetic field transducer; further including rendering a position of at least one of the magnetic field sources using the predetermined number of angles; the position of the magnetic field transducer corresponds to a position of an object of interest coupled to the magnetic field transducer; the magnetic field transducer includes a magnetometer; the magnetic field sources include a first spinning dipole generated at a first transmitter having a first predetermined position, a second spinning dipole generated at a second transmitter having a second predetermined position, and a third spinning dipole generated at a third transmitter having a third predetermined position, wherein the first, second, and third predetermined positions form a triangle; the triangle is formed about a navigation area of interest including the magnetic field transducer; the magnetic field sources rotate about magnetic field source axes of rotation and are positioned to form a navigation area of interest, further including rotating each magnetic field source axis of rotation about a respective axis perpendicular to a plane formed by the magnetic field sources to align each magnetic field source axis of rotation with a successive one of the magnetic field sources, and; further including rotating at least one of the magnetic field source axes of rotation about a respective axis coincident with the plane formed by the plurality of magnetic field sources to avoid a condition in which the magnetic field transducer is coincident with a plane formed by the magnetic field associated with the at least one magnetic field source axis of rotation.

In another aspect, a computer-readable medium has encoded thereon software for providing navigation information, the software including instructions for determining magnetic field axes of rotation corresponding to rotations of magnetic fields sensed by a magnetic field transducer and associated with magnetic field sources, and processing the magnetic field axes of rotation to render a position of the magnetic field transducer.

In further embodiments, the computer-readable medium has further encoded thereon software instructions for one or more of the following features: processing the magnetic field axes of rotation to render a position of the magnetic field transducer including determining orientations of the magnetic field axes of rotation relative to a predetermined coordinate system, and using the orientations of the magnetic field axes of rotation to render the position of the magnetic field transducer; processing the magnetic field axes of rotation to render a position of the magnetic field transducer includes determining a predetermined number of angles between the magnetic field axes of rotation, and rendering the position of the magnetic field transducer using the predetermined number of angles; the predetermined number of angles is at least three angles and the rendered position includes at least one of position information or orientation information; the predetermined number of angles is six angles and the rendered position includes a three-dimensional position and a three-dimensional orientation; the magnetic field transducer is a rotating magnetic field transducer; further including rendering a position of at least one of the magnetic field sources using the predetermined number of angles; the position of the magnetic field transducer corresponds to a position of an object of interest coupled to the magnetic field transducer, and; the magnetic field transducer comprises a magnetometer.

### BRIEF DESCRIPTION OF THE DRAWINGS

The foregoing features, as well as a detailed description, may be more fully understood from the following description of the drawings in which:

FIG. 1 is a pictorial representation of an embodiment of a navigation system according to the systems and techniques described herein;

FIG. 2 is a pictorial representation of a further embodiment of the navigation system of FIG. 1 using orientations of a magnetic field source axis of rotation to render position;

FIG. 3 is a pictorial representation of another embodiment of the navigation system of FIG. 1 using relative angles between a magnetic field source axes of rotation to render position;

FIG. 4A is a pictorial representation of an embodiment of magnetic dipole placement according to the systems and techniques described herein;

FIG. 4B is a pictorial representation of a further embodiment of the magnetic dipole placement of FIG. 4A;

FIG. 5A is a pictorial representation of an embodiment of magnetic dipole rotation according to the systems and techniques described herein;

FIG. 5B is a pictorial representation of a further embodiment of the magnetic dipole rotation of FIG. 5A;

FIG. 6 is a flow diagram of an embodiment of a method of navigation;

FIG. 7 is a diagram showing an exemplary hardware and operating environment of a suitable computer for use with embodiments of the systems and techniques described herein;

### DETAILED DESCRIPTION

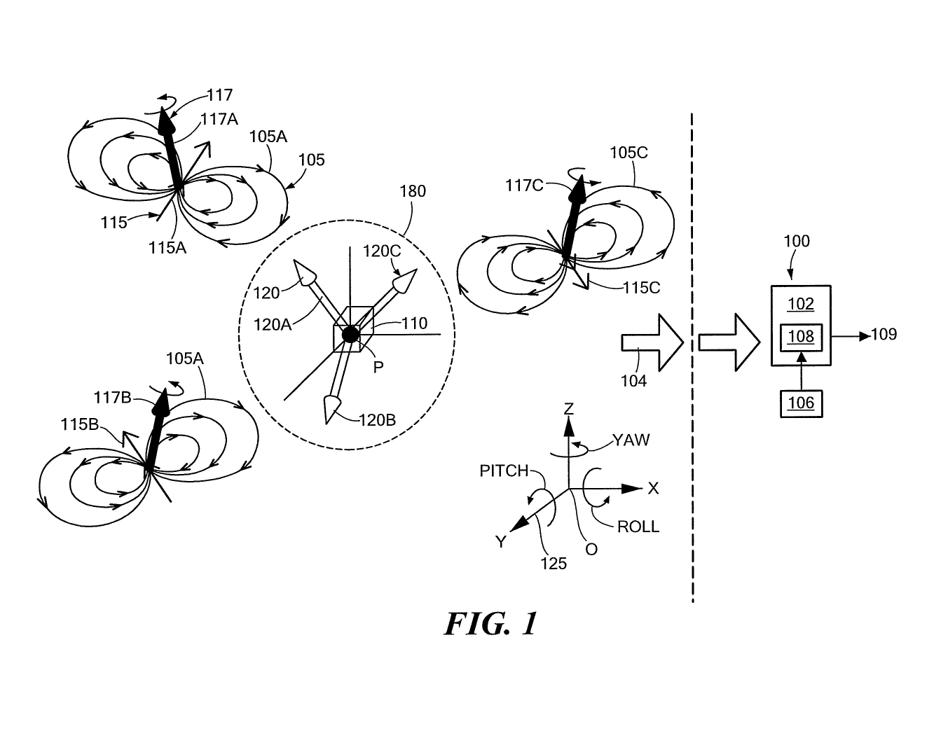

Referring now to FIG. 1, a navigation system 100 includes a processor 102 configured to receive a magnetic field signal 104 from a magnetic field transducer 110. The magnetic field signal 104 is proportional to sensed magnetic fields 105A, 105B, 105C (generally designated by reference numeral 105) associated with magnetic field sources 115A, 115B, 115C (generally designated by reference numeral 115). A memory 106 coupled to the processor 102 includes program instructions 108 for providing navigation information 109 by processing the magnetic field signal 104 to determine magnetic field axes of rotation 120A, 120B, 120C (generally designated by reference numeral 120). The magnetic field axes of rotation 120 correspond to rotations 117A, 117B, 117C (generally designated by reference numeral 117) of the sensed magnetic fields 105. The program instructions 108 provide navigation information 109 which in some embodiments includes providing navigation information corresponding to a position P of the magnetic field transducer 110 using the magnetic field axes of rotation 120.

In further embodiments, the processor 102 receives the magnetic field signal 104 from the magnetic field transducer 110 over a wired connection. In the same or different embodiment, the processor 102 receives the magnetic field signal 104 from the magnetic field transducer 110 over a wireless connection. In some embodiments, the magnetic field signal 104 is a voltage proportional to sensed magnetic fields 105A, 105B, 105C and the proportionality factor of voltage units to magnetic field units may be unknown.

In further embodiments, the magnetic field transducer 110 is a three-axis magnetometer. As by way of non-limiting examples, the magnetometer 110 may include a Hall effect magnetometer, air-core or rod-core coil magnetometer, a fluxgate magnetometer, various types of scalar and/or vector magnetometers, and/or combinations thereof.

In further embodiments, the magnetic field sources 115 include devices capable of generating magnetic fields including, but not limited to, magnetic dipoles. The magnetic dipoles are rotated about a fixed axis using a variety of methods. For example, the magnetic dipoles may be rotated mechanically (e.g., by spinning a looped current-carrying conductor about a fixed axis) or electrically by appropriate phasing of a current through at least two co-located wire coils. In still further embodiments, a transmitter provides at least two spinning magnetic dipoles, each spinning at different frequencies simultaneously about the same fixed axis. Several of these transmitters may be used as references for the navigation system 100. In some embodiments, transmitters may be placed about a navigation area of interest (as denoted by dotted line designated by reference numeral 180) including the magnetic field transducer 110. For example, in some embodiments, three transmitters may form a triangle about the magnetic field transducer 110.

It should be readily apparent to one of ordinary skill in the art that other devices capable of generating magnetic fields may be used including rod-core antennas with high-permeability cores. An advantage of rod-core antenna embodiments is the ability to navigate from a signal that is corrupted by non-linear effects of a high-power rod-core antenna.

In a further embodiment, the magnetic field axes of rotation 120 are defined relative to a predetermined coordinate system 125 used to define a three-dimensional position P of a navigation object, such as the magnetic field transducer 110 or an object coupled to the magnetic field transducer 110. X, Y, and Z axes represent three dimensions of the predetermined coordinate system 125 and intersect at the origin O of the predetermined coordinate system 125. In some embodiments, the X dimension corresponds to a longitude position, the Y dimension corresponds to a latitude position, and the Z dimension corresponds to an altitude position of navigation objects in geometric coordinates. These navigation objects may include the above-described transmitters and/or the magnetic field transducer 110 and/or objects coupled to the magnetic field transducer 110.

An orientation of the magnetic field transducer 110 may be defined with reference to the X, Y, and Z axes of the predetermined coordinate system 125. The orientation may be defined as a combination of roll, pitch, and yaw angles about the X, Y, and Z axes, respectively. The orientation of the magnetic field transducer may be aligned with the X, Y, and Z axes (roll, pitch, and yaw equal to zero), however, in some embodiments, the magnetic field transducer 110 may not be aligned with 125. In these embodiments, devices including, but not limited to, an inclinometer, gyroscope, and/or compass may be used to calculate and provide the offset.

An embodiment of a geometric technique to render the position P of the magnetic field transducer 110 using the orientations of the magnetic field axis of rotations 120 relative to the predetermined coordinate system 125 will now be described. At any given point in space, a magnetic field generated by a magnetic field source, such as one of the above-mentioned spinning magnetic dipoles, can be described by a magnetic field axis of rotation. At some distance from the spinning magnetic dipole, the magnetic field axis of rotation defines a plane in a manner similar to the plane defined by the spinning magnetic dipole A relationship between a magnetic field axis of rotation associated with a spinning dipole and the magnetic field generated by the spinning dipole is represented by the following equation:

\hat{n}ᵢ·\vec{H}ᵢ(t)=0

where \hat{n}ᵢ represents a vector corresponding to the magnetic field axis of rotation associated with an i^{th} spinning magnetic dipole and ·\vec{H}ᵢ(t) represents a magnetic field of the i^{th} spinning magnetic dipole.

The orientation of magnetic field transducer 110 may be known, in which case the orientations of the magnetic field axes of rotation 120 can be determined relative the predetermined coordinate system 125. A combination of these orientations may be used to render a position P of the magnetic field transducer 110.

The geometric technique may be defined as a series of steps to render position P including the following:
(1) Measure magnetic field axes of rotation \hat{n}ᵢ
(2) Determine orientation of \hat{n}ᵢ relative to the predetermined coordinate system, and
(3) Render the position of the magnetic field transducer using orientation information of step (2).

A non-limiting technique to measure magnetic field axes of rotation \hat{n}ᵢ will now be described. Suppose that two coils for the i^{th} spinning magnetic dipole of a transmitter are driven according to functions cos ωᵢt and sin ωᵢt, respectively. A relationship between a sensed magnetic field \vec{H}ᵢ(t) and these functions may be represented by the following equation:

\vec{H}ᵢ(t)= R̅(t)[\vec{I}ᵢ cos ωᵢt+\vec{Q}ᵢ sin ωᵢt] Equation 1

Here, \vec{I}ᵢ and \vec{Q}ᵢ do not change over the integration time because the spinning magnetic dipole is stable over short periods and the receiver is not translating. R̅(t) is a time-varying rotation matrix.

The vector \hat{n}ᵢ is given by the following equation:

$${\hat{n}}_{i} = \frac{{{I}^{->}}_{i} \times {{Q}^{->}}_{i}}{‖ {{I}^{->}}_{i} \times {{Q}^{->}}_{i} ‖} \qquad Equation 2$$

Here, \hat{n}ᵢ can be said to be normal to \vec{H}ᵢ(t) if R̅(t)= I̅ for all measurement times. Compensating sensors, if used, are used to modify the rotation matrix R̅(t).

When a magnetic field transducer is rotating (i.e., its orientation is changing over time), equation 2 is still defined though \vec{I}ᵢ and \vec{Q}ᵢ cannot be measured directly.

It has been stated that the technique presented here is stable even when the transmitter is unstable. This is because the magnetic field axis of rotation \hat{n}ᵢ does not depend on transmitter moment and phase. In other words, the magnetic field axis of rotation does not change if the rotation phase or amplitude of the dipole changes from one measurement time to another measurement time, nor does the technique require a common clock between transmitter and receiver. For example, if the clock of the transmitter changes, then the following relationship is defined:

\vec{I}ᵢ cos ωᵢt+\vec{Q}ᵢ sin ωᵢt→\vec{I}ᵢ cos(ωᵢt+α)+\vec{Q}ᵢ sin(ωᵢt+α)=(cos α\vec{I}ᵢ+sin α\vec{Q}ᵢ)cos ωᵢt+(−sin α\vec{I}ᵢ+cos α\vec{Q}ᵢ)sin ωᵢt

Furthermore, the following is also defined:

$$\begin{matrix}{{I}^{->}}_{i}^{perceived} \times {{Q}^{->}}_{i}^{percieved} = ( cos α {{I}^{->}}_{i} + sin α {{Q}^{->}}_{i} ) \times ( - sin α {{I}^{->}}_{i} + cos α {{Q}^{->}}_{i} ) \\ = - sin α cos α {{I}^{->}}_{i} \times {{I}^{->}}_{i} + {cos}^{2} α {{I}^{->}}_{i} \times {{Q}^{->}}_{i} - \\ {sin}^{2} α {{Q}^{->}}_{i} \times {{I}^{->}}_{i} + sin αcosα {{Q}^{->}}_{i} \times {{Q}^{->}}_{i} \\ = ( {cos}^{2} α + {sin}^{2} α ) {{I}^{->}}_{i} \times {{Q}^{->}}_{i} \\ = {{I}^{->}}_{i} \times {{Q}^{->}}_{i}\end{matrix}$$

A general relationship to define a perceived axis of rotation \hat{n}ᵢ^{perceived} is given by:

$${\hat{n}}_{i}^{percieved} = \frac{{{I}^{->}}_{i}^{percieved} \times {{Q}^{->}}_{i}^{percieved}}{‖ {{I}^{->}}_{i}^{percieved} \times {{Q}^{->}}_{i}^{percieved} ‖} = \frac{{{I}^{->}}_{i} \times {{Q}^{->}}_{i}}{‖ {{I}^{->}}_{i} \times {{Q}^{->}}_{i} ‖} = {\hat{n}}_{i}$$

In other words, the axis of rotation defined at the receiver is unchanged by clock drift at the transmitter.

If the orientation of the receiver is not known or changing ( R̅(t)≠ I̅ or without compensation) the dot product of i^{th} and j^{th} spinning dipoles may still be determined using the following equation:

$$\begin{matrix}{\hat{n}}_{i} \cdot {\hat{n}}_{j} = \frac{{{I}^{->}}_{i} \times {{Q}^{->}}_{i}}{‖ {{I}^{->}}_{i} \times {{Q}^{->}}_{i} ‖} \cdot \frac{{{I}^{->}}_{j} \times {{Q}^{->}}_{j}}{‖ {{I}^{->}}_{j} \times {{Q}^{->}}_{j} ‖} \\ = \frac{{{I}^{->}}_{i} \cdot {{I}^{->}}_{j} {{Q}^{->}}_{i} \cdot {{Q}^{->}}_{j} - {{I}^{->}}_{j} \cdot {{Q}^{->}}_{i} {{I}^{->}}_{i} \cdot {{Q}^{->}}_{j}}{\begin{matrix}\sqrt{{{I}^{->}}_{i} \cdot {{I}^{->}}_{i} {{Q}^{->}}_{i} \cdot {{Q}^{->}}_{i} - {( {{I}^{->}}_{i} \cdot {{Q}^{->}}_{i} )}^{2}} \\ \sqrt{{{I}^{->}}_{j} \cdot {{I}^{->}}_{j} {{Q}^{->}}_{j} \cdot {{Q}^{->}}_{j} - {( {{I}^{->}}_{j} \cdot {{Q}^{->}}_{j} )}^{2}}\end{matrix}}\end{matrix} \qquad Equation 3$$

Using Equation 1 as a model, the dot product of \vec{H}ᵢ(t)·\vec{H}ⱼ(t) may be defined by the following equation:

$${{H}^{->}}_{i} ( t ) \cdot {{H}^{->}}_{j} ( t ) = ( \frac{{{I}^{->}}_{i} \cdot {{I}^{->}}_{j}}{2} - \frac{{{Q}^{->}}_{i} \cdot {{Q}^{->}}_{j}}{2} ) cos ( {ω}_{i} + {ω}_{j} ) t + ( \frac{{{I}^{->}}_{i} \cdot {{I}^{->}}_{j}}{2} + \frac{{{Q}^{->}}_{i} \cdot {{Q}^{->}}_{j}}{2} ) cos ( {ω}_{i} - {ω}_{j} ) t + ( \frac{{{I}^{->}}_{i} \cdot {{Q}^{->}}_{j}}{2} + \frac{{{I}^{->}}_{j} \cdot {{Q}^{->}}_{i}}{2} ) sin ( {ω}_{i} + {ω}_{j} ) t + ( - \frac{{{I}^{->}}_{i} \cdot {{Q}^{->}}_{j}}{2} + \frac{{{I}^{->}}_{j} \cdot {{Q}^{->}}_{i}}{2} ) sin ( {ω}_{i} - {ω}_{j} ) t \qquad Equation 4$$

Equation 4 may be generalized as follows:

\vec{H}ᵢ(t)·\vec{H}ᵢ(t)=c₊cos(ωᵢ+ωⱼ)t+c₋cos(ωᵢ−ωⱼ)t+s₊sin(ωᵢ+ωⱼ)t+s₋sin(ωᵢ−ωⱼ)t Equation 4.5

Here, c₊, c₋, s₊, and s₋ are the fit parameters.

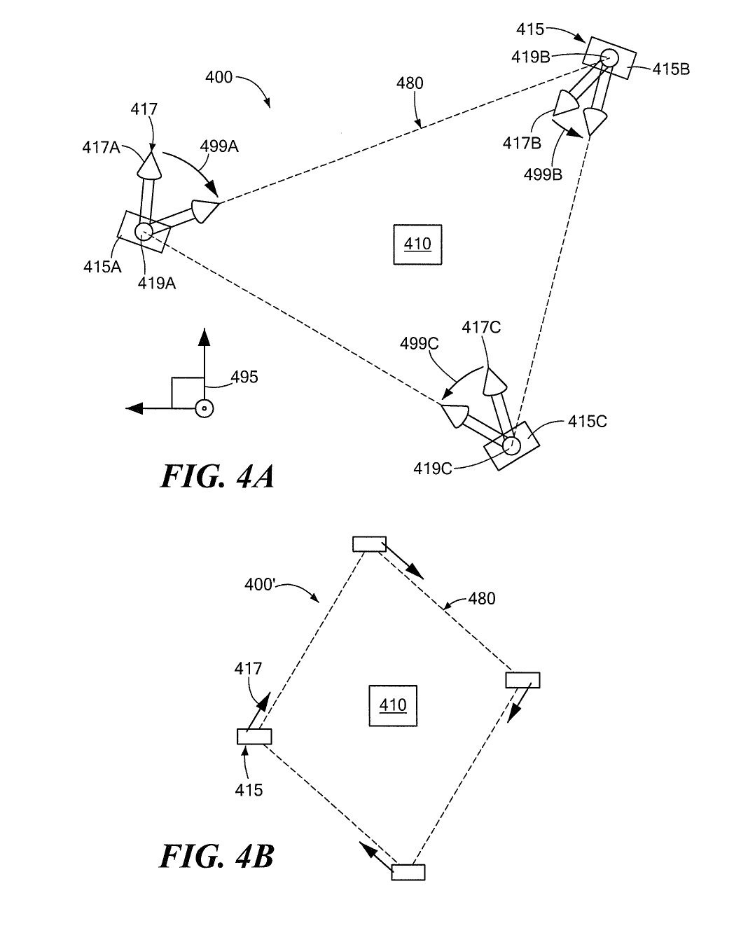

By fitting the data to the above equation 4.5 the right hand IQ terms of equation 4 may be derived, thus giving (using equation 3) the angle between axes of rotation as shown in FIG. 3.

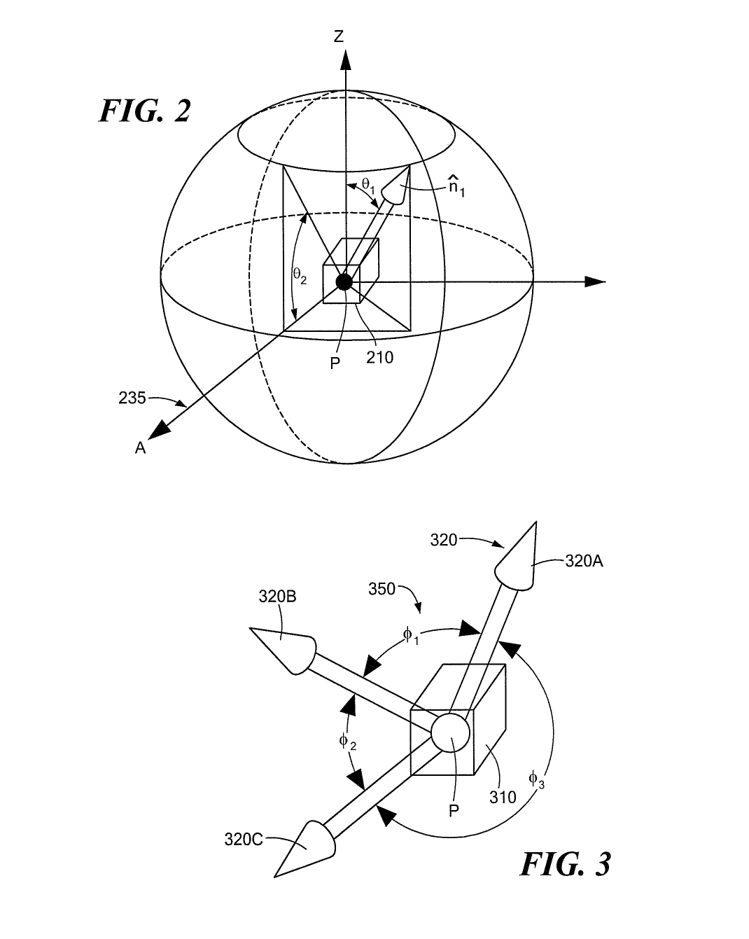

FIG. 2 illustrates a non-limiting example of a magnetic field axis of rotation \hat{n}ᵢ and its orientation relative to a predetermined coordinate system 225 defined in a spherical coordinates by azimuth reference axis A and zenith reference axis Z representative of three-dimensional space. Here, the orientation of magnetic field axis of rotation \hat{n}₁ is defined by components θ₁ and θ₂. Component θ₁ represents an inclination (or polar angle) between axis Z and \hat{n}₁, and component θ₂ represents an azimuth (or azimuthal angle) between axis A to the orthogonal projection of \hat{n}₁ on a plane formed by A-Z axes. In FIG. 2, P represents a position of a magnetic field transducer 210, as may be similar to magnetic field transducer 110 discussed in conjunction with FIG. 1.

Referring now to FIG. 3 showing magnetic field axes of rotation 320 (as may be similar to magnetic field axes of rotation 120 discussed in conjunction with FIG. 1) which correspond to rotations of magnetic fields sensed by a magnetic field transducer 310, in a further embodiment, a predetermined number of angles 350 between the magnetic field axes of rotation 320 are used to render a position P of the magnetic field transducer 310. In a further embodiment, the predetermined number of angles 350 is at least three angles and the rendered position includes at least one of position information or orientation information.

As by way of a non-limiting example, a first one of the three predetermined angles φ₁ is formed between a first magnetic field axis of rotation 320A and a second magnetic field axis of rotation 320B, a second one of the three angles φ₂ is formed between the second magnetic field axis of rotation 320B and a third magnetic field axis of rotation 320C, and a third one of the three angles φ₃ is formed between the first magnetic field axis of rotation 320A and the third magnetic field axis of rotation 320C. In still a further embodiment, the predetermined number of angles is six angles formed between at least four magnetic field axes of rotation and the rendered position includes a three-dimensional position (having an X, Y, and Z component) and a three-dimensional orientation (having a roll, pitch, and yaw component).

An embodiment of a geometric technique to render a position P of the magnetic field transducer 310 will now be described. After the collection of magnetic field axes of rotation have been measured using equation 2, one may solve for \hat{r}ᵢ, which is the unit vector pointing from the i^{th} spinning dipole to the magnetic field transducer position using the following equation for \hat{r}ᵢ:

$${\hat{n}}_{i} = \frac{- 2 {\hat{u}}_{i} + 3 ( {\hat{u}}_{i} \cdot {\hat{r}}_{i} ) {\hat{r}}_{i}}{\sqrt{4 - 3 {( {\hat{u}}_{i} \cdot {\hat{r}}_{i} )}^{2}}}$$

Here, the unit vector ûᵢ is the axis of rotation of the i^{th} spinning magnetic dipole. The position P of the magnetic field transducer 310 may be found the \hat{r}ᵢ using the closed-form expression:

$${r}^{->} = {[ {\sum }_{i} ( {I}^{\overline{\_}} - {\hat{r}}_{i} {\hat{r}}_{i}^{T} ) ]}^{- 1} {\sum }_{i} ( {I}^{\overline{\_}} - {\hat{r}}_{i} {\hat{r}}_{i}^{T} ) {{s}^{->}}_{i}$$

where \vec{s}ᵢ is the location of the i^{th} spinning magnetic dipole in defined in a predetermined coordinate system (as may be similar to predetermined coordinate system 125 described in conjunction with FIG. 1) and \vec{r} is the XYZ description of the position P.

For the case where the orientation of the magnetic field transducer 310 is unknown (or uncompensated), an embodiment of a differential geometric technique to render a position P of the magnetic field transducer 310 will now be described. The position P of the magnetic field transducer 310 may be estimated by minimizing a loss function indicative of a difference between estimated and theoretical position values. More particularly, the loss function is based on the estimated angles (e.g., angles 350) between magnetic field axes of rotation (e.g., magnetic field axes of rotation 320) and theoretical values of the angles based on a magnetic field transducer position.

The loss function L may be defined using the following relationship:

$$L = {\sum }_{m} {\sum }_{n < m} {[ {( {\hat{n}}_{m} \cdot {\hat{n}}_{n} )}_{meas} - {( {\hat{n}}_{m} \cdot {\hat{n}}_{n} )}_{theo} ]}^{2}$$

In some embodiments, a loss function L may be minimized by a gradient search, which requires one to compute the derivative of the loss function with respect to user location. The dot product of theoretical values for axes of rotation \hat{n}ₘ and \hat{n}ₙ of respective m^{th} and n^{th} spinning dipoles may be represented by the following equation:

$${( {\hat{n}}_{m} \cdot {\hat{n}}_{n} )}_{theo} = \frac{\begin{matrix}4 {\hat{u}}_{m} \cdot {\hat{u}}_{n} - 6 {d}_{m} {\hat{u}}_{n} \cdot {\hat{r}}_{m} - \\ 6 {d}_{n} {\hat{u}}_{m} \cdot {\hat{r}}_{n} + 9 {d}_{m} {d}_{n} {\hat{r}}_{m} \cdot {\hat{r}}_{n}\end{matrix}}{\sqrt{( 4 - 3 {d}_{m}^{2} ) ( 4 - 3 {d}_{n}^{2} )}} \qquad Equation 5$$

and a derivative of the theoretical values with respect to a receiver location \vec{r}, may be represented by:

$$\frac{\partial {( {\hat{n}}_{m} \cdot {\hat{n}}_{n} )}_{theo}}{\partial {r}^{->}} = \frac{1}{{R}_{m} \sqrt{( 4 - 3 {d}_{n}^{2} )}} ( I - {\hat{r}}_{m} {\hat{r}}_{mj}^{T} ) [ 12 {\hat{u}}_{m} {\hat{r}}_{m} + 3 {d}_{m} ( 4 - 3 {d}_{m}^{2} ) I - 6 {d}_{m} {\hat{u}}_{m} {\hat{u}}_{m}^{T} ] [ - 2 {\hat{u}}_{n} + 3 {d}_{n} {\hat{r}}_{n} ] + c . c \qquad Equation 6$$

In equation 5, ûₙ is the axis of rotation of an n^{th} spinning magnetic dipole, \hat{r}ₙ is the unit vector pointing from the n^{th} spinning dipole to the magnetic field transducer position, and dₙ is the dot product ûₙ·\hat{r}ₙ. Respective variables are defined for the m^{th} spinning dipole. In equation 6, Rₘ is the range from the magnetic field transducer to the m^{th} spinning dipole, \vec{r} is the magnetic field transducer position, and c.c represents a second term exchanging indices in and n in equation 6. Equations 5 and 6 are sufficient to generate a gradient search for the loss function L.

In a further embodiment, the above-described differential geometric technique is used to render a position of a magnetic field source using the predetermined number of angles and multiple receiver measurements. In these embodiments, the magnetic field source may be the above-described spinning magnetic dipole and the receiver may be the above-described receiver magnetometer. A matrix relationship defines a derivative of a magnetic field axis of rotation with respect to a spinning dipole axis of rotation as follows:

$$\frac{\partial {\hat{n}}_{m}}{\partial {\hat{u}}_{m}} = \frac{\begin{matrix}- 2 ( 4 {\hat{u}}_{m} \cdot {\hat{u}}_{m} - 3 {d}_{m}^{2} ) I + 12 {\hat{u}}_{m} \cdot {\hat{u}}_{m} {\hat{r}}_{m} {\hat{r}}_{m}^{T} + \\ 8 {\hat{u}}_{m} {\hat{u}}_{m}^{T} - 12 {d}_{m} {\hat{u}}_{m} {\hat{r}}_{m}^{T} - 6 {d}_{m} {\hat{r}}_{m} {\hat{u}}_{m}^{T}\end{matrix}}{{( 4 {\hat{u}}_{m} \cdot {\hat{u}}_{m} - 3 {d}_{m}^{2} )}^{\frac{3}{2}}}$$

Here, the variables correspond to an m^{th} spinning dipole. This matrix relationship (which in some embodiments may be referred to as a Frechet derivative) may be combined with the chain rule to compute a gradient of a loss function L described above in conjunction with equations 5 and 6.

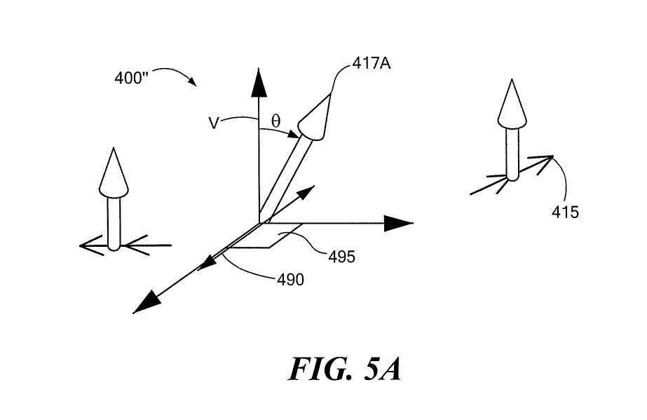

Referring now to FIG. 4A, in a further embodiment 400, magnetic field sources (generally designated by reference numeral 415) are positioned to form a navigation area of interest (denoted by dotted line designated by reference numeral 480) about an object 410 whose position is to be determined. The object 410 may be a receiver magnetometer, as may be similar to receiver magnetometer 110 discussed in conjunction with FIG. 1. The magnetic field sources 415 are co-planar 495 (which for illustrative purposes, is coincident with the plane of the paper) and, in some embodiments, may optionally include a first spinning dipole 415A rotating about a first axis 417A, a second spinning dipole 415B rotating about a second axis 417B, and a third spinning dipole 415C rotating about a third axis 417C. In these embodiments, the spinning dipoles 415A, 415B, 415C may optionally be positioned to form an equilateral triangle about a navigation area of interest 480.

In some embodiments, spinning dipole axes of rotation (generally designated by reference numeral 417) are aligned toward successive ones of the spinning dipoles 415. In particular, each axis 417A, 417B, 417C is rotated about a respective axis perpendicular to the plane 495 to align each axis 417A, 417B, 417C with a successive one of the other spinning dipoles 415. For example, the first spinning dipole axis of rotation 417A is rotated 499A about position 419A toward position 419B of the second spinning dipole 415B. Furthermore, the second spinning dipole axis of rotation 417B is rotated 499B about position 419B toward position 419C of the third spinning dipole 415C, and the third spinning dipole axis of rotation 417C is rotated 499C about position 419C toward position 419A of the first spinning dipole 417B.

Referring now to FIG. 4B, in which like elements of FIG. 4A are shown with like reference numerals, the successively aligned spinning dipole axes of rotation 417 discussed in conjunction with FIG. 4A may be generalized to any number of spinning dipoles 415 which form a navigation area 480 about an object of interest 410. For example, FIG. 4B illustrates an embodiment 400′ including four spinning dipoles 415 forming a navigation area of interest 480 about object 410 and whose axes of rotation 417 have been aligned with successive ones of the spinning dipoles 415.

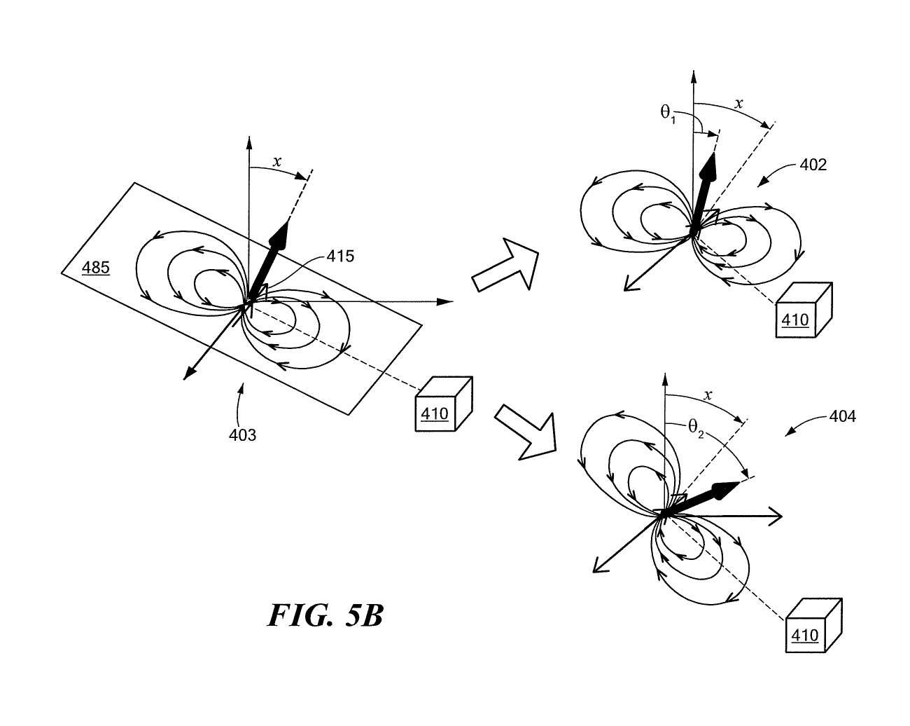

Referring now to FIG. 5A, in which like elements of FIGS. 4A and 4B are shown with like reference numerals, in other embodiments 400″, at least one of the magnetic field source axes of rotation (an example of which is designated by reference numeral 417A) is rotated an angle θ about a respective axis 496 coincident with the plane 495 formed by the plurality of magnetic field sources 415. Here, for illustrative purposes only, angle θ is defined with reference to an axis V corresponding to a vertical direction (i.e., out of the plane of the page). In some embodiments, angle θ is less than 90 degrees and is selected to minimize and/or eliminate navigation error in one or more navigation directions. For example, in some navigation environments, as θ increases vertical navigation error tends to decrease while horizontal navigation error tends to increase. Such tradeoffs may be exploited to achieve higher navigation accuracy in one or more dimensions depending on the needs of an environment incorporating the systems and techniques described herein. For example, depth determination may be critical in deep mining operations, in which case angle θ may be selected to improve depth navigation accuracy, with some acceptable sacrifice in horizontal navigation accuracy. In other applications, horizontal navigation may be more important, such as when an object whose position is to be determined tends to move along a level surface and angle θ may be accordingly selected to improve horizontal navigation accuracy. It should be noted that in some embodiments, angle θ may be modified in response to one or more movements of the object 410.

Referring now to FIG. 5B, in which like elements of FIG. 5A are shown with like reference numerals, an angle χ defined with reference to an axis V corresponding to a vertical direction is such that a plane 485 formed by a magnetic field of a spinning dipole 415 intersects an object of interest 410 whose position is to be determined. Such a relationship 403 can produce significant navigation errors. In some embodiments, this relationship 403 is avoided by selecting angle θ to be different than angle χ. FIG. 5B shows one embodiment 402 in which angle θ is less than angle χ (i.e. angle θ₁) and another embodiment 404 in which angle θ is greater than angle χ (i.e. angle θ₂). It should be noted that in some embodiments, angle θ may be updated in response to one or more movements of the object 410 which result in a change to angle χ. In some embodiment, angle θ is selected to prevent relationship 403 from occurring within the navigation area.

It should be noted that the systems, methods, and techniques described herein may optionally include Kalman filtering techniques.

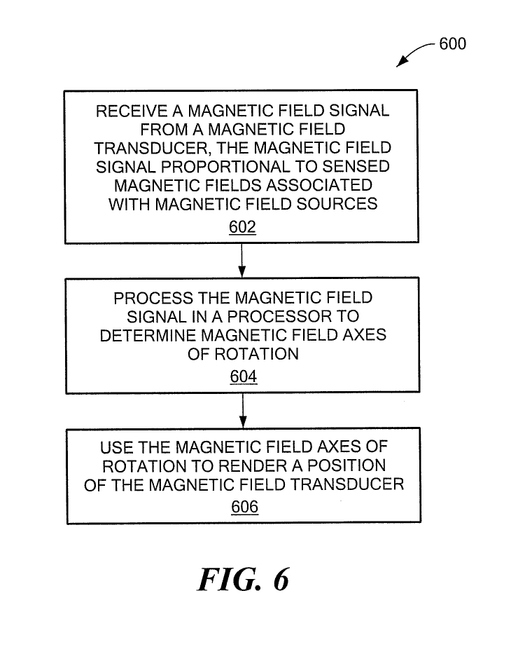

Referring now to FIG. 6, in one aspect, a navigation method 600 includes receiving a magnetic field signal from a magnetic field transducer, the magnetic field signal proportional to sensed magnetic fields associated with magnetic field sources (602) and, in a processor, processing the magnetic field signal to determine a magnetic field axes of rotation corresponding to rotations of the sensed magnetic fields (604). The method 600 includes using the plurality of magnetic field axes of rotation to render a position of the magnetic field transducer (606).

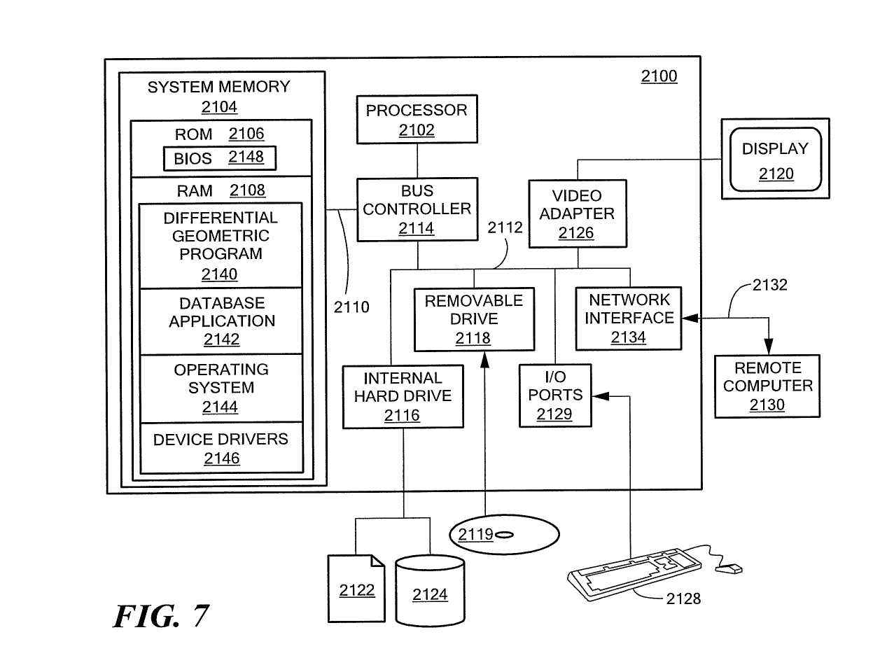

FIG. 7 illustrates a computer 2100 suitable for supporting the operation of an embodiment of the inventive systems and techniques described herein. The computer 2100 includes a processor 2102, for example, a desktop processor, laptop processor, server and workstation processor, and/or embedded and communications processor. As by way of a non-limiting example, processor 2102 may include an Intel® Core™ i7, i5, or i3 processor manufactured by the Intel Corporation of Santa Clara, Calif. However, it should be understood that the computer 2100 may use other microprocessors. Computer 2100 can represent any server, personal computer, laptop, or even a battery-powered mobile device such as a hand-held personal computer, personal digital assistant, or smart phone.

Computer 2100 includes a system memory 2104 which is connected to the processor 2102 by a system data/address bus 2110. System memory 2104 includes a read-only memory (ROM) 2106 and random access memory (RAM) 2108. The ROM 2106 represents any device that is primarily read-only including electrically erasable programmable read-only memory (EEPROM), flash memory, etc. RAM 2108 represents any random access memory such as Synchronous Dynamic Random Access Memory (SDRAM). The Basic Input/Output System (BIOS) 2148 for the computer 2100 is stored in ROM 2106 and loaded into RAM 2108 upon booting.

Within the computer 2100, input/output (I/O) bus 2112 is connected to the data/address bus 2110 via a bus controller 2114. In one embodiment, the I/O bus 2112 is implemented as a Peripheral Component Interconnect (PCI) bus. The bus controller 2114 examines all signals from the processor 2102 to route signals to the appropriate bus. Signals between processor 2102 and the system memory 2104 are passed through the bus controller 2114. However, signals from the processor 2102 intended for devices other than system memory 2104 are routed to the I/O bus 2112.

Various devices are connected to the I/O bus 2112 including internal hard drive 2116 and removable storage drive 2118 such as a CD-ROM drive used to read a compact disk 2119 or a floppy drive used to read a floppy disk. The internal hard drive 2116 is used to store data, such as in files 2122 and database 2124. Database 2124 includes a structured collection of data, such as a relational database. A display 2120, such as a cathode ray tube (CRT), liquid-crystal display (LCD), etc. is connected to the I/O bus 2112 via a video adapter 2126.

A user enters commands and information into the computer 2100 by using input devices 2128, such as a keyboard and a mouse, which are connected to I/O bus 2112 via I/O ports 2129. Other types of pointing devices that may be used include track balls, joy sticks, and tracking devices suitable for positioning a cursor on a display screen of the display 2120.

Computer 2100 may include a network interface 2134 to connect to a remote computer 2130, an intranet, or the Internet via network 2132. The network 2132 may be a local area network or any other suitable communications network.

Computer-readable modules and applications 2140 and other data are typically stored on memory storage devices, which may include the internal hard drive 2116 or the compact disk 2119, and are copied to the RAM 2108 from the memory storage devices. In one embodiment, computer-readable modules and applications 2140 are stored in ROM 2106 and copied to RAM 2108 for execution, or are directly executed from ROM 2106. In still another embodiment, the computer-readable modules and applications 2140 are stored on external storage devices, for example, a hard drive of an external server computer, and delivered electronically from the external storage devices via network 2132.

The computer-readable modules 2140 may include compiled instructions for implementing the differential geometric techniques and/or geometric techniques to render positions of a magnetic field transducer (which may include a position of an object coupled to the magnetic field transducer) and/or a magnetic field generating sources described herein. The rendered positions may be outputted to display 2120 to enable users to view the positions. Further, position information may be outputted to other components of a navigation system and/or other types of systems which may use such information. As by way of non-limiting examples, position information may be outputted to military command and control systems, drilling and exploration systems used in mining operations, vehicle tracking and/or routing control systems.

In a further embodiment, the computer 2100 may execute a first differential geometric program on a first processor to render position information for a first object of interest and a second geometric program on a second processor to render position information for a second object of interest. For example, the first and second processor may be respective processors of a dual-core processor. Alternatively, the first and second processor may respective first and second computing devices.

The computer 2100 may execute a database application 2142, such as Oracle™ database from Oracle Corporation, to model, organize, and query data stored in database 2124. The data may be used by the computer-readable modules and applications 2140 and/or passed over the network 2132 to the remote computer 2130 and other systems.

In general, the operating system 2144 executes computer-readable modules and applications 2140 and carries out instructions issued by the user. For example, when the user wants to execute a computer-readable module 2140, the operating system 2144 interprets the instruction and causes the processor 2102 to load the computer-readable module 2140 into RAM 2108 from memory storage devices. Once the computer-readable module 2140 is loaded into RAM 2108, the processor 2102 can use the computer-readable module 2140 to carry out various instructions. The processor 2102 may also load portions of computer-readable modules and applications 2140 into RAM 2108 as needed. The operating system 2144 uses device drivers 2146 to interface with various devices, including memory storage devices, such as hard drive 2116 and removable storage drive 2118, network interface 2134, I/O ports 2129, video adapter 2126, and printers.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method of navigation, comprising:
receiving a magnetic field signal from a magnetic field transducer, the magnetic field signal proportional to sensed magnetic fields associated with a plurality of magnetic field sources;
in a processor, processing the magnetic field signal to determine a plurality of magnetic field axes of rotation corresponding to rotations of the sensed magnetic fields; and
using the plurality of magnetic field axes of rotation to render a position of the magnetic field transducer.

2. The method of claim 1, wherein said using the plurality of magnetic field axes of rotation to render the position of the magnetic field transducer comprises:
determining a plurality of orientations of the magnetic field axes of rotation relative to a predetermined coordinate system; and
using the plurality of orientations of the magnetic field axes of rotation to render the position of the magnetic field transducer.

3. The method of claim 2, wherein the position of the magnetic field transducer is a fixed position.

4. The method of claim 1, wherein said using the plurality of magnetic field axes of rotation to render the position of the magnetic field transducer comprises:
determining a predetermined number of angles between the magnetic field axes of rotation; and
rendering the position of the magnetic field transducer using the predetermined number of angles.

5. The method of claim 4, wherein the predetermined number of angles is at least three angles and the rendered position includes at least one of position information or orientation information.

6. The method of claim 4, wherein the predetermined number of angles is six angles and the rendered position includes a three-dimensional position and a three-dimensional orientation.

7. The method of claim 4, wherein the magnetic field transducer is a rotating magnetic field transducer.

8. The method of claim 4, further comprising:
rendering a position of at least one of the magnetic field sources using the predetermined number of angles.

9. The method of claim 1, wherein the position of the magnetic field transducer corresponds to a position of an object of interest coupled to the magnetic field transducer.

10. The method of claim 1, wherein the magnetic field transducer comprises a magnetometer.

11. The method of claim 1, wherein the plurality of magnetic field sources comprises:
a first spinning dipole generated at a first transmitter having a first predetermined position;
a second spinning dipole generated at a second transmitter having a second predetermined position; and
a third spinning dipole generated at a third transmitter having a third predetermined position,
wherein the first, second, and third predetermined positions form a triangle.

12. The method of claim 11, wherein the triangle is formed about a navigation area of interest including the magnetic field transducer.

13. The method of claim 1, wherein the plurality of magnetic field sources rotate about a plurality of magnetic field source axes of rotation and are positioned to form a navigation area of interest, further comprising:
rotating each magnetic field source axis of rotation about a respective axis perpendicular to a plane formed by the plurality of magnetic field sources to align each magnetic field source axis of rotation with a successive one of the magnetic field sources.

14. The method of claim 13, further comprising:
rotating at least one of the magnetic field source axes of rotation about a respective axis coincident with the plane formed by the plurality of magnetic field sources to avoid a condition in which the magnetic field transducer is coincident with a plane formed by the magnetic field associated with the at least one magnetic field source axis of rotation.

15. A navigation system, comprising:
a processor to receive a magnetic field signal from a magnetic field transducer, the magnetic field signal proportional to sensed magnetic fields associated with a plurality of magnetic field sources;
a memory coupled to the processor, the memory including program instructions for providing navigation information by:
processing the magnetic field signal to determine a plurality of magnetic field axes of rotation corresponding to rotations of the sensed magnetic fields; and
using the plurality of magnetic field axes of rotation to render a position of the magnetic field transducer.

16. The system of claim 15, said using the plurality of magnetic field axes of rotation to render a position of the magnetic field transducer comprises:
determining a plurality of orientations of the magnetic field axes of rotation relative to a predetermined coordinate system; and
using the plurality of orientations of the magnetic field axes of rotation to render the position of the magnetic field transducer.

17. The system of claim 16, wherein the position of the magnetic field transducer is a fixed position.

18. The system of claim 15, said using the plurality of magnetic field axes of rotation to render a position of the magnetic field transducer comprises:
determining a predetermined number of angles between the magnetic field axes of rotation; and
rendering a position of the magnetic field transducer using the predetermined number of angles.

19. The system of claim 18, wherein the predetermined number of angles is at least three angles and the rendered position includes at least one of position information or orientation information.

20. The system of claim 18, wherein the predetermined number of angles is six angles and the rendered position includes a three-dimensional position and a three-dimensional orientation.

21. The system of claim 18, wherein the magnetic field transducer is a rotating magnetic field transducer.

22. The system of claim 18, further comprising:
rendering a position of at least one of the magnetic field sources using the predetermined number of angles.

23. The system of claim 15, wherein the position of the magnetic field transducer corresponds to a position of an object of interest coupled to the magnetic field transducer.

24. The system of claim 15, wherein the magnetic field transducer comprises a magnetometer.

25. The system of claim 15, wherein the plurality of magnetic field sources comprises:
a first spinning dipole generated at a first transmitter having a first predetermined position;
a second spinning dipole generated at a second transmitter having a second predetermined position; and
a third spinning dipole generated at a third transmitter having a third predetermined position,
wherein the first, second, and third predetermined positions form a triangle.

26. The system of claim 25, wherein the triangle is formed about a navigation area of interest including the magnetic field transducer.

27. The system of claim 15, wherein the plurality of magnetic field sources rotate about a plurality of magnetic field source axes of rotation and are positioned to form a navigation area of interest, further comprising:
rotating each magnetic field source axis of rotation about a respective axis perpendicular to a plane formed by the plurality of magnetic field sources to align each magnetic field source axis of rotation with a successive one of the magnetic field sources.

28. The system of claim 27, further comprising:
rotating at least one magnetic field source axis of rotation about a respective axis coincident with the plane formed by the plurality of magnetic field sources to avoid a condition in which the magnetic field transducer is coincident with a plane formed by the magnetic field associated with the at least one magnetic field source axis of rotation.

29. A computer-readable medium having encoded thereon software for providing navigation information, said software comprising instructions for:
determining a plurality of magnetic field axes of rotation corresponding to rotations of magnetic fields sensed by a magnetic field transducer and associated with a plurality of magnetic field sources; and
processing the plurality of magnetic field axes of rotation to render a position of the magnetic field transducer.

30. The computer-readable medium of claim 1, wherein said processing the plurality of magnetic field axes of rotation to render a position of the magnetic field transducer comprises:
determining a plurality of orientations of the magnetic field axes of rotation relative to a predetermined coordinate system; and
using the plurality of orientations of the magnetic field axes of rotation to render the position of the magnetic field transducer.

31. The computer-readable medium of claim 29, wherein said processing the plurality of magnetic field axes of rotation to render a position of the magnetic field transducer comprises:
determining a predetermined number of angles between the magnetic field axes of rotation; and
rendering the position of the magnetic field transducer using the predetermined number of angles.

32. The computer-readable medium of claim 31, wherein the predetermined number of angles is at least three angles and the rendered position includes at least one of position information or orientation information.

33. The computer-readable medium of claim 31, wherein the predetermined number of angles is six angles and the rendered position includes a three-dimensional position and a three-dimensional orientation.

34. The computer-readable medium of claim 31, wherein the magnetic field transducer is a rotating magnetic field transducer.

35. The computer-readable medium of claim 31, said software further comprising instructions for:
rendering a position of at least one of the magnetic field sources using the predetermined number of angles.

36. The computer-readable medium of claim 29, wherein the position of the magnetic field transducer corresponds to a position of an object of interest coupled to the magnetic field transducer.

37. The computer-readable medium of claim 29, wherein the magnetic field transducer comprises a magnetometer.
